(19) United States
(12) Patent Application Publication
(10) Pub. No.: US 2016/0353482 A1
(43) Pub. Date: Dec. 1, 2016

(54) RESERVATION COORDINATION IN A SHARED COMMUNICATION MEDIUM

(71) Applicant: QUALCOMM Incorporated, San Diego, CA (US)

(72) Inventors: Nachiappan VALLIAPPAN, San Diego, CA (US); Ahmed Kamel SADEK, San Diego, CA (US); Tamer Adel KADOUS, San Diego, CA (US)

(21) Appl. No.: 14/845,049

(22) Filed: Sep. 3, 2015

Related U.S. Application Data
(60) Provisional application No. 62/167,180, filed on May 27, 2015.

(51) Int. Cl. H04W 74/08; H04L 5/22; H04W 74/00

(52) U.S. Cl. CPC H04W 74/0816; H04W 74/004; H04L 5/22; H04W 88/06

(57) ABSTRACT

Techniques for reservation coordination and related operations in shared spectrum are disclosed. Communication over a communication medium may be performed in accordance with a first Radio Access Technology (RAT) and in accordance with a communication pattern of active periods and inactive periods of communication. A channel reservation message may be transmitted in accordance with a second RAT to reserve the communication medium for one of the active periods. The channel reservation message may be transmitted randomly at a plurality of successive burst slots. In addition or as an alternative, one or more medium access parameters associated with the channel reservation message may be set to a value below a threshold associated with aggressive contention.

### CROSS-REFERENCE TO RELATED APPLICATIONS

The present application for patent claims the benefit of U.S. Provisional Application No. 62/167,180, entitled “RESERVATION COORDINATION IN SHARED SPECTRUM,” filed May 27, 2015, assigned to the assignee hereof, and expressly incorporated herein by reference in its entirety.

### INTRODUCTION

Aspects of this disclosure relate generally to telecommunications, and more particularly to co-existence between wireless Radio Access Technologies (RATs) and the like.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Long Term Evolution (LTE) provided by the Third Generation Partnership Project (3GPP), Ultra Mobile Broadband (UMB) and Evolution Data Optimized (EV-DO) provided by the Third Generation Partnership Project 2 (3GPP2), 802.11 provided by the Institute of Electrical and Electronics Engineers (IEEE), etc.

In cellular networks, “macro cell” access points provide connectivity and coverage to a large number of users over a certain geographical area. A macro network deployment is carefully planned, designed, and implemented to offer good coverage over the geographical region. To improve indoor or other specific geographic coverage, such as for residential homes and office buildings, additional “small cell,” typically low-power access points have recently begun to be deployed to supplement conventional macro networks. Small cell access points may also provide incremental capacity growth, richer user experience, and so on.

Small cell LTE operations, for example, have been extended into the unlicensed frequency spectrum such as the Unlicensed National Information Infrastructure (U-NII) band used by Wireless Local Area Network (WLAN) technologies. This extension of small cell LTE operation is designed to increase spectral efficiency and hence capacity of the LTE system. However, it may also encroach on the operations of other Radio Access Technologies (RATs) that typically utilize the same unlicensed bands, most notably IEEE 802.11x WLAN technologies generally referred to as “Wi-Fi.”

### SUMMARY

The following summary is an overview provided solely to aid in the description of various aspects of the disclosure and is provided solely for illustration of the aspects and not limitation thereof

In one example, a communication apparatus is disclosed. The apparatus may include, for example, a first transceiver, a second transceiver, at least one processor, and at least one memory coupled to the at least one processor. The first transceiver may be configured to communicate over a communication medium in accordance with a first Radio Access Technology (RAT) and in accordance with a communication pattern of active periods and inactive periods of communication. The second transceiver may be configured to transmit, over the communication medium, a channel reservation message in accordance with a second RAT to reserve the communication medium for one of the active periods. The at least one processor and the at least one memory may be configured to direct the second transceiver to randomly transmit the channel reservation message at a plurality of successive burst slots.

In another example, a method of communication is disclosed. The method may include, for example, communicating over a communication medium in accordance with a first RAT and in accordance with a communication pattern of active periods and inactive periods of communication; and transmitting, over the communication medium, a channel reservation message in accordance with a second RAT to reserve the communication medium for one of the active periods, the channel reservation message being transmitted randomly at a plurality of successive burst slots.

In another example, another communication apparatus is disclosed. The apparatus may include, for example, means for communicating over a communication medium in accordance with a first RAT and in accordance with a communication pattern of active periods and inactive periods of communication; and means for transmitting, over the communication medium, a channel reservation message in accordance with a second RAT to reserve the communication medium for one of the active periods, the channel reservation message being transmitted randomly at a plurality of successive burst slots.

In another example, a transitory or non-transitory computer-readable medium is disclosed. The computer-readable medium may include, for example, code for communicating over a communication medium in accordance with a first RAT and in accordance with a communication pattern of active periods and inactive periods of communication; and code for transmitting, over the communication medium, a channel reservation message in accordance with a second RAT to reserve the communication medium for one of the active periods, the channel reservation message being transmitted randomly at a plurality of successive burst slots.

In one example, a communication apparatus is disclosed. The apparatus may include, for example, a first transceiver, a second transceiver, at least one processor, and at least one memory coupled to the processor. The first transceiver may be configured to communicate over a communication medium in accordance with a first RAT and in accordance with a communication pattern of active periods and inactive periods of communication. The second transceiver may be configured to transmit, over the communication medium, a channel reservation message in accordance with a second RAT to reserve the communication medium for one of the active periods. The at least one processor and the at least one memory may be configured to set one or more medium access parameters associated with the channel reservation message to a value below a threshold associated with aggressive contention.

In another example, another method of communication is disclosed. The method may include, for example, communicating over a communication medium in accordance with a first RAT and in accordance with a communication pattern of active periods and inactive periods of communication; transmitting, over the communication medium, a channel reservation message in accordance with a second RAT to reserve the communication medium for one of the active periods; and setting one or more medium access parameters associated with the channel reservation message to a value below a threshold associated with aggressive contention.

In another example, another communication apparatus is disclosed. The apparatus may include, for example, means for communicating over a communication medium in accordance with a first RAT and in accordance with a communication pattern of active periods and inactive periods of communication; means for transmitting, over the communication medium, a channel reservation message in accordance with a second RAT to reserve the communication medium for one of the active periods; and means for setting one or more medium access parameters associated with the channel reservation message to a value below a threshold associated with aggressive contention.

In another example, another transitory or non-transitory computer-readable medium is disclosed. The computer-readable medium may include, for example, code for communicating over a communication medium in accordance with a first RAT and in accordance with a communication pattern of active periods and inactive periods of communication; code for transmitting, over the communication medium, a channel reservation message in accordance with a second RAT to reserve the communication medium for one of the active periods; and code for setting one or more medium access parameters associated with the channel reservation message to a value below a threshold associated with aggressive contention.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communication system including an access point in communication with an access terminal.

FIG. 2 illustrates certain aspects of an example Discontinuous Transmission (DTX) communication scheme.

FIG. 3 is a timing diagram illustrating an example reservation coordination mechanism that employs aggressive contention.

FIG. 4 is a timing diagram illustrating another example reservation coordination mechanism that employs synchronized reservation.

FIG. 5 is a timing diagram illustrating another example reservation coordination mechanism that employs randomized reservation bursting.

FIG. 6 is a timing diagram illustrating another example reservation coordination mechanism that employs preamble bursting.

FIG. 7 is a flow diagram illustrating an example communication method.

FIG. 8 is a flow diagram illustrating another example communication method.

FIG. 9 illustrates an example access point apparatus represented as a series of interrelated functional modules.

FIG. 10 illustrates another example access point apparatus represented as a series of interrelated functional modules.

### DETAILED DESCRIPTION

The present disclosure relates generally to techniques for reservation coordination on a communication medium shared between Radio Access Technologies (RATs). Access points or other devices utilizing channel reservation messages defined for one RAT (e.g., Wi-Fi) to reserve access to the communication medium for communication in accordance with another RAT (e.g., LTE) may be interfered with by other traffic on the communication medium, including other channel reservation messages. A coordinated approach among the access points or other devices may help to mitigate this issue. Coordination may include, for example, aggressive contention, synchronized reservation, randomized reservation bursting, preamble bursting, and other techniques or combinations thereof.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

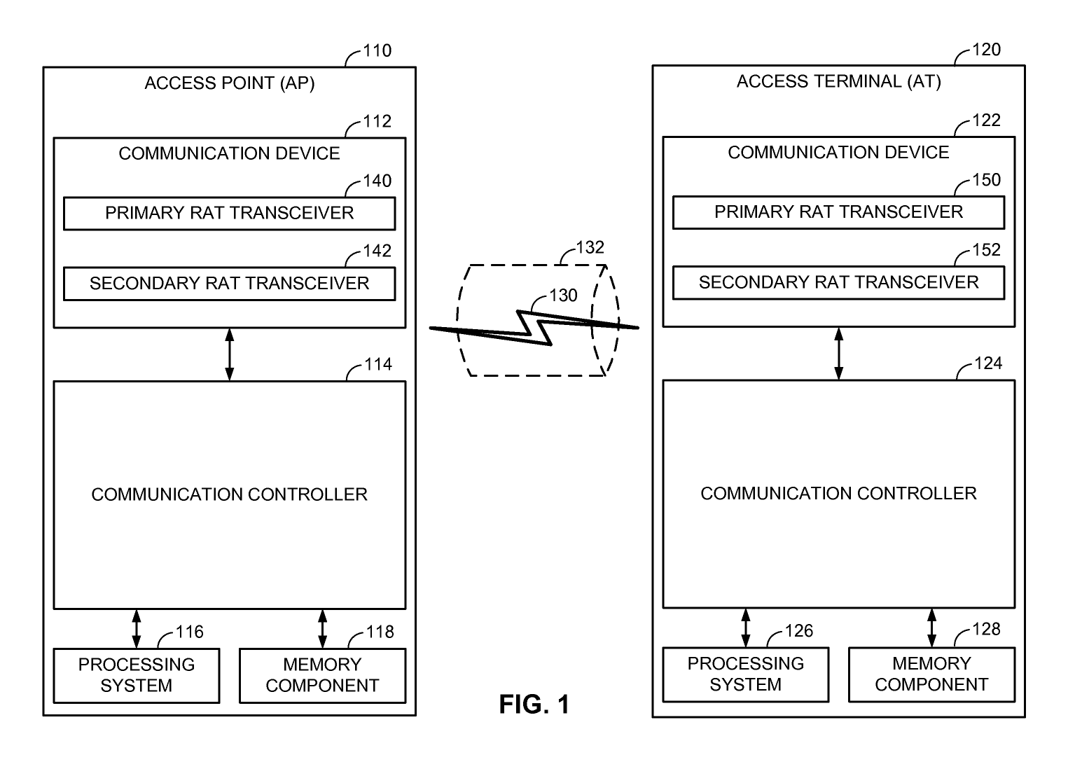

FIG. 1 illustrates an example wireless communication system including an access point in communication with an access terminal Unless otherwise noted, the terms “access terminal” and “access point” are not intended to be specific or limited to any particular Radio Access Technology (RAT). In general, access terminals may be any wireless communication device allowing a user to communicate over a communications network (e.g., a mobile phone, router, personal computer, server, entertainment device, Internet of Things (JOT)/Internet of Everything (JOE) capable device, in-vehicle communication device, etc.), and may be alternatively referred to in different RAT environments as a User Device (UD), a Mobile Station (MS), a Subscriber Station (STA), a User Equipment (UE), etc. Similarly, an access point may operate according to one or several RATs in communicating with access terminals depending on the network in which the access point is deployed, and may be alternatively referred to as a Base Station (BS), a Network Node, a NodeB, an evolved NodeB (eNB), etc. Such an access point may correspond to a small cell access point, for example. “Small cells” generally refer to a class of low-powered access points that may include or be otherwise referred to as femto cells, pico cells, micro cells, Wireless Local Area Network (WLAN) access points, other small coverage area access points, etc. Small cells may be deployed to supplement macro cell coverage, which may cover a few blocks within a neighborhood or several square miles in a rural environment, thereby leading to improved signaling, incremental capacity growth, richer user experience, and so on.

In the example of FIG. 1, the access point 110 and the access terminal 120 each generally include a wireless communication device (represented by the communication devices 112 and 122) for communicating with other network nodes via at least one designated RAT. The communication devices 112 and 122 may be variously configured for transmitting and encoding signals (e.g., messages, indications, information, and so on), and, conversely, for receiving and decoding signals (e.g., messages, indications, information, pilots, and so on) in accordance with the designated RAT. The access point 110 and the access terminal 120 may also each generally include a communication controller (represented by the communication controllers 114 and 124) for controlling operation of their respective communication devices 112 and 122 (e.g., directing, modifying, enabling, disabling, etc.). The communication controllers 114 and 124 may operate at the direction of or otherwise in conjunction with respective host system functionality (illustrated as the processing systems 116 and 126 and the memory components 118 and 128 coupled to the processing systems 116 and 126, respectively, and configured to store data, instructions, or a combination thereof, either as on-board cache memory, separate components, a combination, etc.). In some designs, the communication controllers 114 and 124 may be partly or wholly subsumed by the respective host system functionality.

Turning to the illustrated communication in more detail, the access terminal 120 may transmit and receive messages via a wireless link 130 with the access point 110, the message including information related to various types of communication (e.g., voice, data, multimedia services, associated control signaling, etc.). The wireless link 130 may operate over a communication medium of interest, shown by way of example in FIG. 1 as the communication medium 132, which may be shared with other communications as well as other RATs. A medium of this type may be composed of one or more frequency, time, and/or space communication resources (e.g., encompassing one or more channels across one or more carriers) associated with communication between one or more transmitter/receiver pairs, such as the access point 110 and the access terminal 120 for the communication medium 132.

As an example, the communication medium 132 may correspond to at least a portion of an unlicensed frequency band shared with other RATs. In general, the access point 110 and the access terminal 120 may operate via the wireless link 130 according to one or more RATs depending on the network in which they are deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks, in particular those employing small cell access points, have extended operation into unlicensed frequency bands such as the Unlicensed National Information Infrastructure (U-NII) band used by WLAN technologies, most notably IEEE 802.11x WLAN technologies generally referred to as “Wi-Fi.”

In the example of FIG. 1, the communication device 112 of the access point 110 includes two co-located transceivers operating according to respective RATs, including a primary-RAT transceiver 140 configured to operate in accordance with one RAT to predominantly communicate with the access terminal 120 and a secondary-RAT transceiver 142 configured to operate in accordance with another RAT to predominantly interact with other-RAT devices that may be sharing the communication medium 132. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a WLAN chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The primary-RAT transceiver 140 and the secondary-RAT transceiver 142 may provide different functionalities and may be used for different purposes. As an example, the primary-RAT transceiver 140 may operate in accordance with Long Term Evolution (LTE) technology to provide communication with the access terminal 120 on the wireless link 130, while the secondary-RAT transceiver 142 may operate in accordance with WLAN technology to monitor or control WLAN signaling on the communication medium 132 that may interfere with or be interfered with by the LTE communications. The secondary-RAT transceiver 142 may or may not serve as a full WLAN access point providing communication services to an associated Basic Service Set (BSS). The communication device 122 of the access terminal 120 may, in some designs, include similar primary-RAT transceiver and/or secondary-RAT transceiver functionality, as shown in FIG. 1 by way of the primary-RAT transceiver 150 and the secondary-RAT transceiver 152, although such dual-transceiver functionality may not be required.

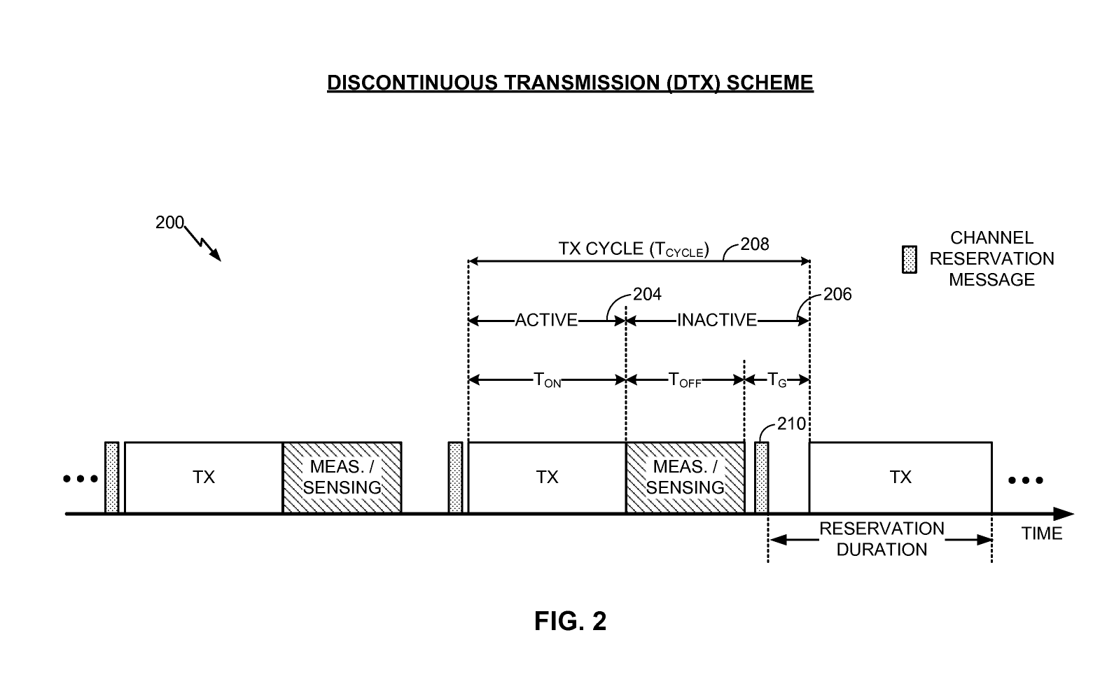

FIG. 2 illustrates certain aspects of an example Discontinuous Transmission (DTX) communication scheme that may be implemented on the communication medium 132. The DTX communication scheme may be used to foster co-existence between (i) primary RAT communications between the access point 110 and access terminal 120 and (ii) other, secondary RAT communications between neighboring devices, for example, by switching operation of the primary RAT over the communication medium 132 between active periods 204 of communication and inactive periods 206 of communication.

During a period of time T_{ON} associated with each active period 204, primary RAT transmission on the communication medium 132 may proceed at a normal, relatively high transmission power (TX_{HIGH}). During a period of time T_{OFF} associated with each inactive period 206, however, primary RAT transmission on the communication medium 132 is disabled or at least sufficiently reduced to a relatively low transmission power (TX_{LOW}) in order to yield the communication medium 132 to neighboring devices operating according to the secondary RAT. During this time, various network listening functions and associated measurements may be performed, as desired, such as medium utilization measurements, medium utilization sensing, and so on. A given active period 204/inactive period 206 pair may constitute a DTX cycle 208 having a length T_{CYCLE} equal to the sum of T_{ON} and T_{OFF}. One or more DTX cycles 208 may collectively form a DTX communication pattern 200.

In some DTX communication schemes, the switching between active periods 204 and inactive periods 206 may be largely predefined (e.g., periodic) and referred to as a Time Division Multiplexing (TDM) communication scheme. A TDM communication scheme may be characterized by a corresponding TDM communication pattern defining the location (timing) of the active periods 204 and inactive periods 206 via a set of one or more TDM parameters. Each of the associated TDM parameters, including, for example, a period (i.e., the length of T_{CYCLE}), a duty cycle (i.e., T_{ON}/T_{CYCLE}) and the respective transmission powers during active periods 204 and inactive periods 206 (TX_{HIGH} and TX_{LOW}, respectively), may be adapted based on the current signaling conditions on the communication medium 132 to dynamically optimize the TDM communication scheme. For example, the secondary-RAT transceiver 142 configured to operate in accordance with the secondary RAT (e.g., WLAN) may be further configured to monitor the communication medium 132 during the time period T_{OFF} for secondary RAT signaling, which may interfere with or be interfered with by primary RAT communications over the communication medium 132. The communication controller 114 may be configured to determine a utilization metric associated with utilization of the communication medium 132 by the secondary RAT signaling. Based on the utilization metric, the associated parameters may be set and the primary-RAT transceiver 140 configured to operate in accordance with the primary RAT (e.g., LTE) may be further configured to cycle between active periods 204 of communication and inactive periods 206 of communication over the communication medium 132 in accordance therewith. As an example, if the utilization metric is high (e.g., above a threshold), one or more of the parameters may be adjusted such that usage of the communication medium 132 by the primary-RAT transceiver 140 is reduced (e.g., via a decrease in the duty cycle or transmission power). Conversely, if the utilization metric is low (e.g., below a threshold), one or more of the parameters may be adjusted such that usage of the communication medium 132 by the primary-RAT transceiver 140 is increased (e.g., via an increase in the duty cycle or transmission power).

In other DTX communication schemes, the switching between active periods 204 and inactive periods 206 may be conditional and referred to as a Listen Before Talk (LBT) communication scheme. An LBT communication scheme is a contention-based protocol in which the period of time T_{OFF} associated with each inactive period 206 may be used as a sensing interval for assessment of the communication medium 132 to determine whether to seize it or back off. For example, the secondary-RAT transceiver 142 configured to operate in accordance with the secondary RAT (e.g., WLAN) may be further configured to monitor the communication medium 132 during the time period T_{OFF} for secondary RAT signaling, and the communication controller 114 may be configured to determine if other secondary RAT devices are transmitting on the communication medium 132 before initiating the next active period 204. When no such transmissions are detected (e.g., above a signaling threshold), the next active period 204 may be initiated. When transmissions are in fact detected, the next active period 204 may be delayed (e.g., for a backoff period, after which the contention procedure is repeated).

Returning to FIG. 2, in order to improve synchronization with neighboring secondary RAT devices, a channel reservation message 210 defined for the secondary RAT may be transmitted over the communication medium 132 via the secondary-RAT transceiver 142 to reserve the communication medium 132 for primary RAT operation during the upcoming active period 204. Example channel reservation messages may include, for example, Clear-to-Send-to-Self (CTS2S) messages, Request-to-Send (RTS) messages, Clear-to-Send (CTS) messages, Physical Layer Convergence Protocol (PLCP) headers (e.g., L-SIG, HT-SIG, VHT-SIG), and the like for a secondary Wi-Fi RAT, or other similar messages defined for other secondary RATs of interest. When appropriate, the channel reservation message 210 may include a duration indication or the like corresponding to the duration of the upcoming active period 204 (e.g., a Network Allocation Vector (NAV)). By utilizing a channel reservation mechanism built into the secondary RAT itself, greater protection may be obtained for primary RAT communication during the active period 204 as compared to relying on other, less-sensitive channel sensing mechanisms geared towards inter-RAT traffic (e.g., a Wi-Fi Clear Channel Assessment (CCA) Energy Detection (ED) mechanism for the neighboring secondary RAT devices to assess the state of the communication medium 132 prior to attempting transmission).

Because channel reservation is a contention-based procedure, each inactive period 206 may further include a guard period (T_{G}) in which to transmit the channel reservation message 210. Transmission of the channel reservation message 210 may be unsuccessful for a variety of reasons. For example, the channel reservation message 210 may collide with other secondary RAT transmissions (including other channel reservation messages from other entities similarly vying for access for primary RAT communication). In addition, the channel reservation message 210 may be preempted by other, more aggressive secondary RAT transmissions occupying the channel for the duration of the guard period T_{G}, and never be afforded an opportunity for transmission. Several reservation coordination mechanisms are provided herein and discussed below to address such collisions and preemptions.

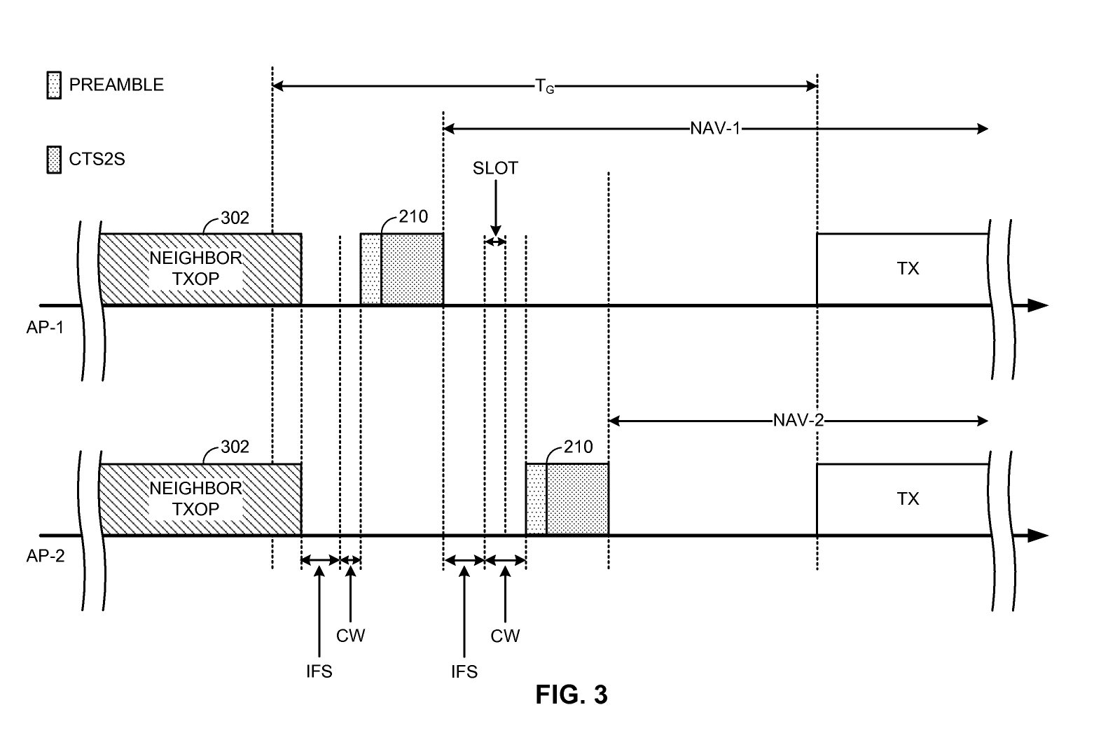

FIG. 3 is a timing diagram illustrating an example reservation coordination mechanism that employs aggressive contention. In this example, two neighboring primary RAT access points AP-1 and AP-2 (e.g., different instances of the access point 110) are operating in accordance with the DTX transmission scheme of FIG. 2 and in the vicinity of one or more neighboring secondary RAT devices sharing the communication medium 132. The two neighboring primary RAT access points AP-1 and AP-2 both contend for access to the communication medium 132 during a given guard period T_{G} to transmit respective channel reservation messages 210 (shown by way of example as a CTS2S message including a standard legacy preamble, such as a Wi-Fi Legacy Signal (L-SIG) header). Contention begins after completion of a transmission opportunity (TXOP) 302 for one of the neighboring secondary RAT devices, which is shown as extending slightly into the guard period T_{G}.

Following completion of the neighbor TXOP 302, each of the neighboring primary RAT access points AP-1 and AP-2 defers access for a predetermined inter-frame spacing (IFS) period and a variable (e.g., randomly selected) contention window (CW). The IFS and CW may be set or modified to promote relatively aggressive contention for the communication medium 132 by primary RAT access points. As used herein, “aggressive contention” refers to the utilization of medium access parameters that are selected to promote quick access to the communication medium 132. As an example, the IFS may be reduced to a relatively small period that helps to ensure capture of the communication medium 132 ahead of neighboring secondary RAT devices. In Wi-Fi, as an example secondary RAT, instead of employing a typical Arbitration Inter-Frame Spacing (AIFS) like the neighboring secondary RAT devices, a shorter PCF Inter-Frame Spacing (PIFS) or Short Inter-Frame Space (SIFS) may be used. Similarly, the CW may also be reduced to a relatively small size that also helps to ensure capture of the communication medium 132 ahead of neighboring secondary RAT devices. In Wi-Fi, as an example secondary RAT, the CW is randomly selected from a range of values (e.g., number of slots) that may be condensed to a range on the order of only a few values (e.g., 0-2 slots), thereby providing the intended randomization effect while still ensuring relatively quick access. The CW range may also be condensed by marking the channel reservation message 210 with a high priority access class such as voice (AC_VO), which receives preferential treatment.

In the illustrated example, the first primary RAT access point AP-1 randomly sets its CW to 1 slot and the second primary RAT access point AP-2 randomly sets its CW to 2 slots. Accordingly, at the completion of the neighbor TXOP 302 and following the IFS (e.g., SIFS) and 1 slot CW, the first primary RAT access point AP-1 seizes the communication medium 132 and transmits its channel reservation message 210 (e.g., a CTS2S message setting a respective first NAV-1 duration to cover the upcoming active period 204). At the completion of the channel reservation message 210 and following the IFS (e.g., SIFS) and 2 slot CW, the second primary RAT access point AP-2 seizes the communication medium 132 and transmits its channel reservation message 210 (e.g., a CTS2S message setting a respective second NAV-2 duration to cover the upcoming active period 204).

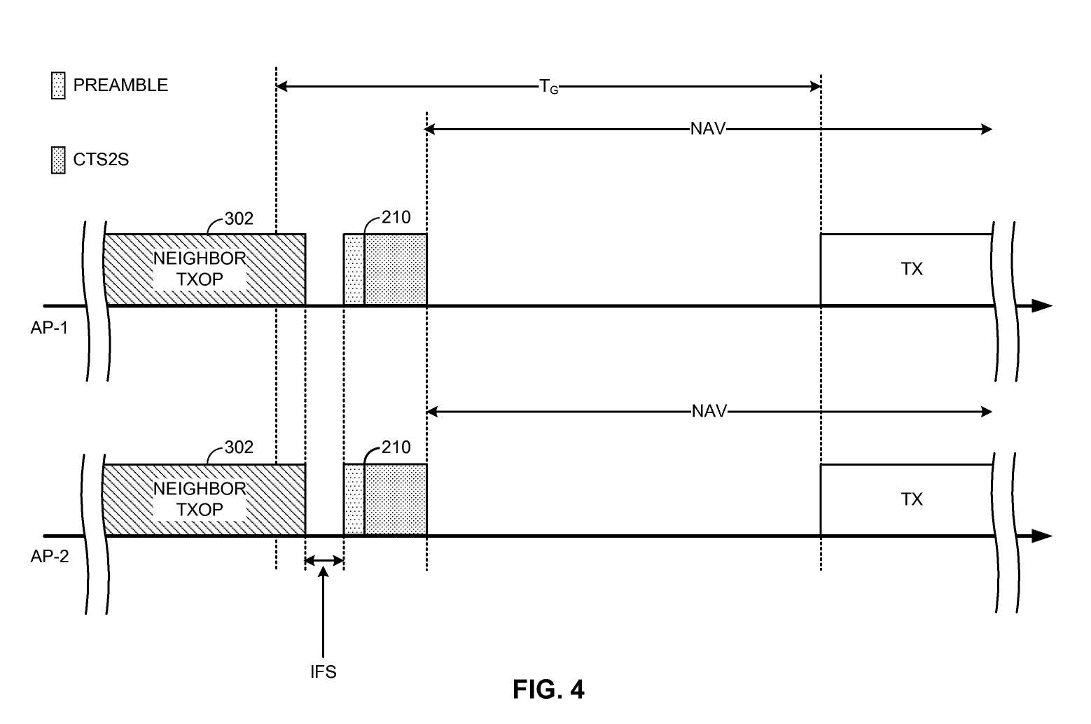

FIG. 4 is a timing diagram illustrating another example reservation coordination mechanism that employs synchronized reservation. As in the example of FIG. 3, two neighboring primary RAT access points AP-1 and AP-2 are again operating in accordance with the DTX transmission scheme of FIG. 2 and in the vicinity of one or more neighboring secondary RAT devices sharing the communication medium 132. The two neighboring primary RAT access points AP-1 and AP-2 both contend for access to the communication medium 132 during a given guard period T_{G} to transmit respective channel reservation messages 210 (shown again by way of example as a CTS2S message including a standard legacy preamble). Contention begins after completion of the neighbor TXOP 302.

In this example, the two neighboring primary RAT access points AP-1 and AP-2 both concurrently transmit respective but identical channel reservation messages 210. (The transmission may proceed after the IFS and CW, although the CW may be restricted or set to 0 since there is no need to stagger transmissions from the two neighboring primary RAT access points AP-1 and AP-2.) In this way, a single frequency network (SFN) effect can be created at the neighboring secondary RAT devices, in which the different transmissions will appear as a resolvable multipath signal (provided that the delay spread caused by propagation is less than, for example, the cyclic prefix (CP) of Wi-Fi, which can be 0.4 or 0.8 microseconds). Each of the channel reservation messages 210 may set the same NAV duration to cover the upcoming active period 204.

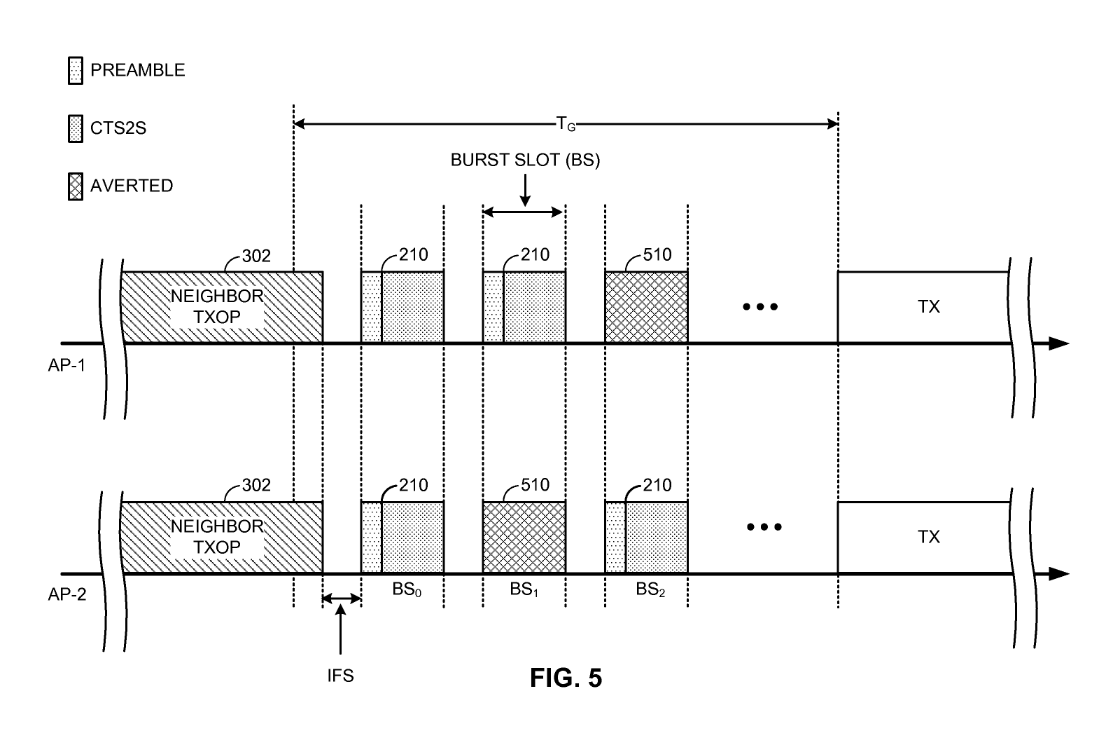

FIG. 5 is a timing diagram illustrating another example reservation coordination mechanism that employs randomized reservation bursting. As in the example of FIG. 3, two neighboring primary RAT access points AP-1 and AP-2 are again operating in accordance with the DTX transmission scheme of FIG. 2 and in the vicinity of one or more neighboring secondary RAT devices sharing the communication medium 132. The two neighboring primary RAT access points AP-1 and AP-2 both contend for access to the communication medium 132 during a given guard period T_{G} to transmit respective channel reservation messages 210 (shown again by way of example as a CTS2S message including a standard legacy preamble). Contention begins after completion of the neighbor TXOP 302.

In this example, a series of successive burst slots (BS) are established during the guard period T_{G} (BSᵢ: BS₀, BS₁, BS₂, . . . , BS_{N}, up to the upcoming active period 204). In each burst slot BSᵢ, each of the neighboring primary RAT access points AP-1 and AP-2 may randomly transmit respective channel reservation messages 210 in accordance with a corresponding probability Pᵢ. This may help to ensure that the communication medium 132 is not given away to neighboring secondary RAT devices after commencement of the guard period T_{G}. Whereas a centralized approach facilitated by a central control entity (e.g., an access point controlling an associated group of access terminals) may instead utilize a coordinated and deterministic transmission ordering of burst slot BSᵢ transmissions among devices, randomization as provided herein may facilitate a decentralized approach (e.g., across access points) that helps to ensure that most if not all burst slots BSᵢ are occupied with a channel reservation message 210 without a central control entity.

Even if there is a collision between channel reservation messages 210 in a given burst slot BSᵢ, the common preamble portion of the channel reservation messages 210 may be nevertheless successfully decoded (appearing as an SFN effect) and therefore cause the neighboring secondary RAT devices to continue to defer access, at least for a time period reaching the next burst slot BSᵢ₊₁ (e.g., for a Wi-Fi Extended Inter-Frame Spacing (EIFS) associated with a cyclic redundancy check (CRC) fail). Further, over a large number of burst slots BS_{N}, each of the neighboring primary RAT access points AP-1 and AP-2 will in all likelihood be afforded a transmission opportunity that is free from collision with other channel reservation messages of neighboring primary RAT access points.

To help ensure that neighboring secondary RAT devices are not able to capture the communication medium 132 between burst slots, the burst slots may start after and be separated by a relatively short IFS (e.g., SIFS). In general, the duration of the IFS may be less than a threshold associated with a contention-based inter-frame spacing defined for the secondary RAT. For example, in Wi-Fi, as an example secondary RAT, the duration of the IFS may be less than the shortest (high priority) AIFS that specifies how long a Wi-Fi node is required to wait before it is allowed to transmit its next frame.

The probability Pᵢ for controlling whether or not to transmit in a given burst slot BSᵢ may be set in various ways to mitigate the potential for collision between channel reservation messages 210. For example, the probability Pᵢ can be derived from the number of neighboring (same operator) primary RAT access points sharing the communication medium 132. A probability Pᵢ that is inversely proportional to the number of neighbors (including the access point itself) can be used to promote uniform access. The number of neighboring primary RAT access points may be determined by a Network Listen (NL) scan database or other information. In addition, the probability Pᵢ can be further derived from the reservation duration required by each of the neighboring primary RAT access points. A probability Pᵢ that is directly proportional to the reservation duration of a given access point relative to its neighbors can be used to prioritize reservations for longer active period 204 (T_{ON}) usage of the communication medium 132. The reservation duration of neighboring access points can be determined by monitoring the communication medium 132 during previous transmission cycles.

In some designs, it may be beneficial for each of the neighboring primary RAT access points to compulsorily transmit in the first burst slot BS₀ with probability P₀=1. Although a collision may result if more than one access point operates within a given vicinity, this transmission may still be used to prevent the neighboring secondary RAT devices from capturing the communication medium 132.

Returning to FIG. 5, in the illustrated example, both of the neighboring primary RAT access points AP-1 and AP-2 transmit respective channel reservation messages 210 in the first burst slot BS₀. Although these transmissions may collide, the preambles may still be successfully decoded and access to the communication medium 132 preserved. In the second burst slot BS₁, the first primary RAT access point AP-1 randomly determines to transmit its channel reservation message 210 and the second primary RAT access point AP-2 randomly determines to refrain from transmitting its channel reservation message 210 (shown as an averted transmission 510). In the third burst slot BS₂, the second primary RAT access point AP-2 randomly determines to transmit its channel reservation message 210 and the first primary RAT access point AP-1 randomly determines to refrain from transmitting its channel reservation message 210 (shown as an averted transmission 510). The neighboring primary RAT access points AP-1 and AP-2 may then continue in this manner to randomly transmit their respective channel reservation messages 210 until the start of the upcoming active period 204, regardless of whether their previous transmissions were successful (which may not be known).

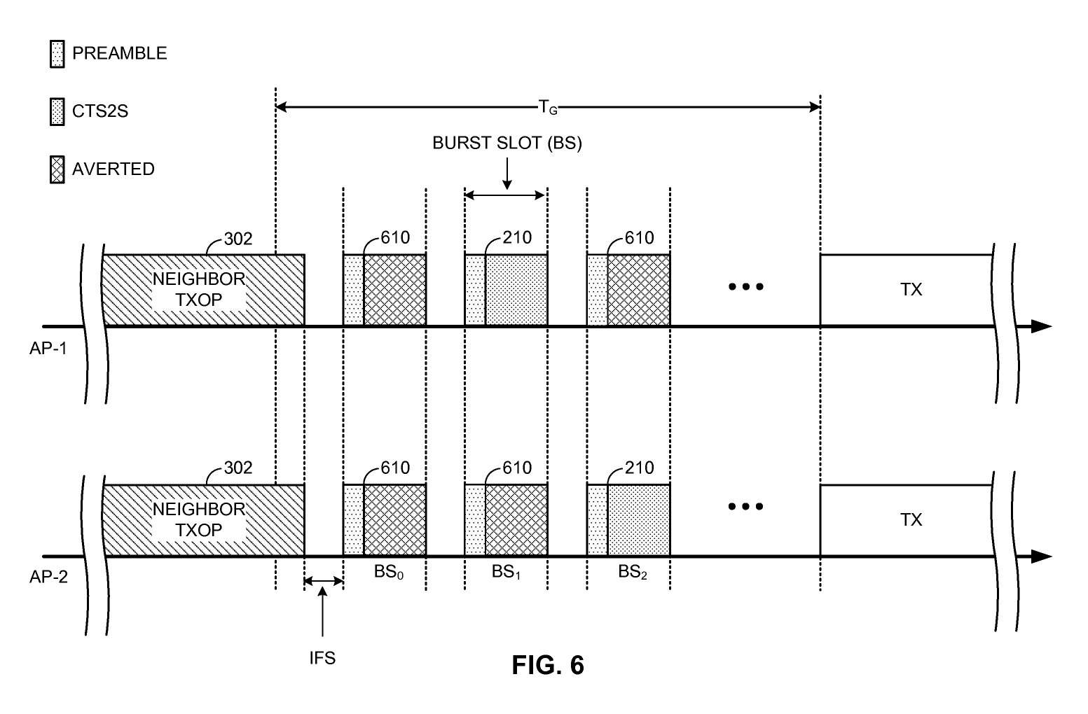

FIG. 6 is a timing diagram illustrating another example reservation coordination mechanism that employs preamble bursting. As in the example of FIG. 3, two neighboring primary RAT access points AP-1 and AP-2 are again operating in accordance with the DTX transmission scheme of FIG. 2 and in the vicinity of one or more neighboring secondary RAT devices sharing the communication medium 132. The two neighboring primary RAT access points AP-1 and AP-2 both contend for access to the communication medium 132 during a given guard period T_{G} to transmit respective channel reservation messages 210 (shown again by way of example as a CTS2S message including a standard legacy preamble). Contention begins after completion of the neighbor TXOP 302.

This example is similar to the example of FIG. 5 except that the neighboring primary RAT access points AP-1 and AP-2 transmit preambles even in burst slots BSᵢ where they randomly determine to refrain from transmitting a full channel reservation message 210 (shown as a partial transmission 610 composed of a preamble followed by an averted transmission in place of, for example, a CTS2S message). By transmitting at least a preamble in each of the burst slots BSᵢ, neighboring secondary RAT devices are prevented from capturing the communication medium 132 even when both the neighboring primary RAT access points AP-1 and AP-2 randomly determine to refrain from transmitting a full channel reservation message 210 (as shown in burst slot BS₀ by way of example).

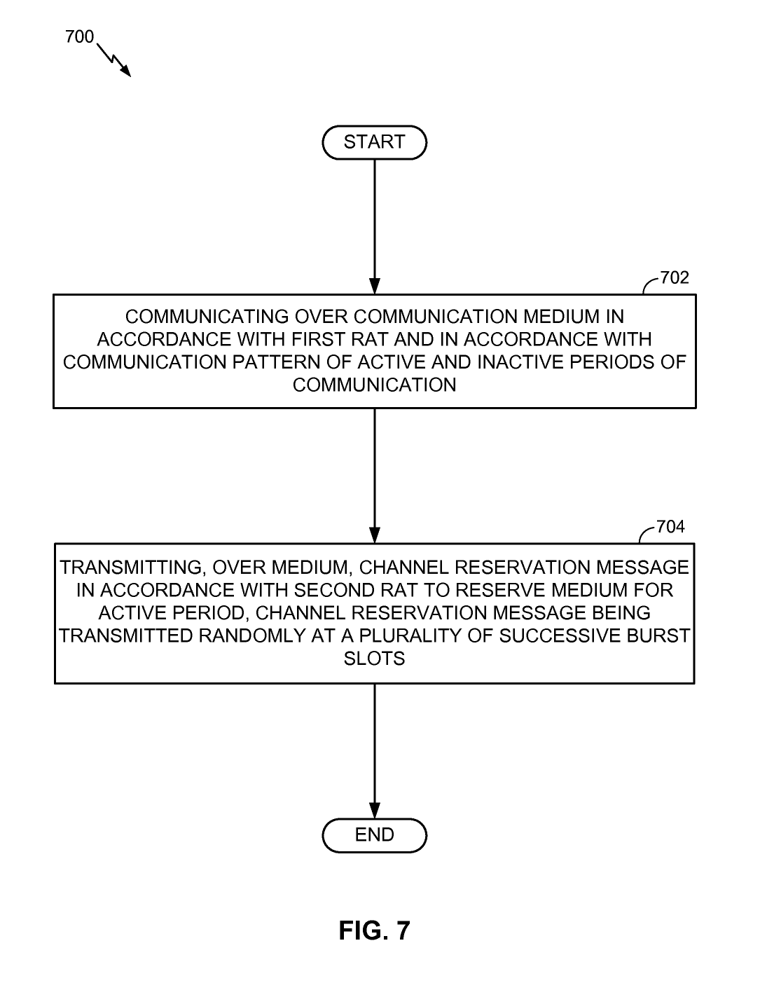

FIG. 7 is a flow diagram illustrating an example method of communication in accordance with the techniques described above. The method 700 may be performed, for example, by an access point (e.g., the access point 110 illustrated in FIG. 1).

As shown, the access point may communicate over a communication medium in accordance with a first RAT and in accordance with a communication pattern of active periods and inactive periods of communication (block 702). The communicating may be performed, for example, by a first transceiver such as the primary-RAT transceiver 140 or the like. As an example, the communication medium may include one or more time, frequency, or space resources on an unlicensed radio frequency band shared between LTE technology and Wi-Fi technology devices. The access point may also transmit, over the communication medium, a channel reservation message in accordance with a second RAT to reserve the communication medium for one of the active periods, the channel reservation message being transmitted randomly at a plurality of successive burst slots (block 704). The transmitting may be performed, for example, by a second transceiver such as the secondary-RAT transceiver 142 or the like in conjunction with a processor such as the processing system 116 or the like.

As discussed in more detail above, the plurality of successive burst slots may be spaced apart by a duration that is less than a threshold amount of time associated with a contention-based inter-frame spacing defined for the second RAT. The channel reservation message may be randomly transmitted in accordance with a probability derived from a number of neighboring first RAT nodes, a reservation duration required by each of the neighboring first RAT nodes, or a combination thereof. The probability for a first burst slot among the plurality of successive burst slots may be set to 1. A packet preamble may be transmitted at each burst slot among the plurality of successive burst slots in which the channel reservation message is not transmitted.

In some designs, communicating over the communication medium may be performed in accordance with a TDM communication pattern defining periodic active and inactive periods of communication. In other designs, communicating over the communication medium may be performed in accordance with an LBT communication pattern defining conditional active and inactive periods of communication.

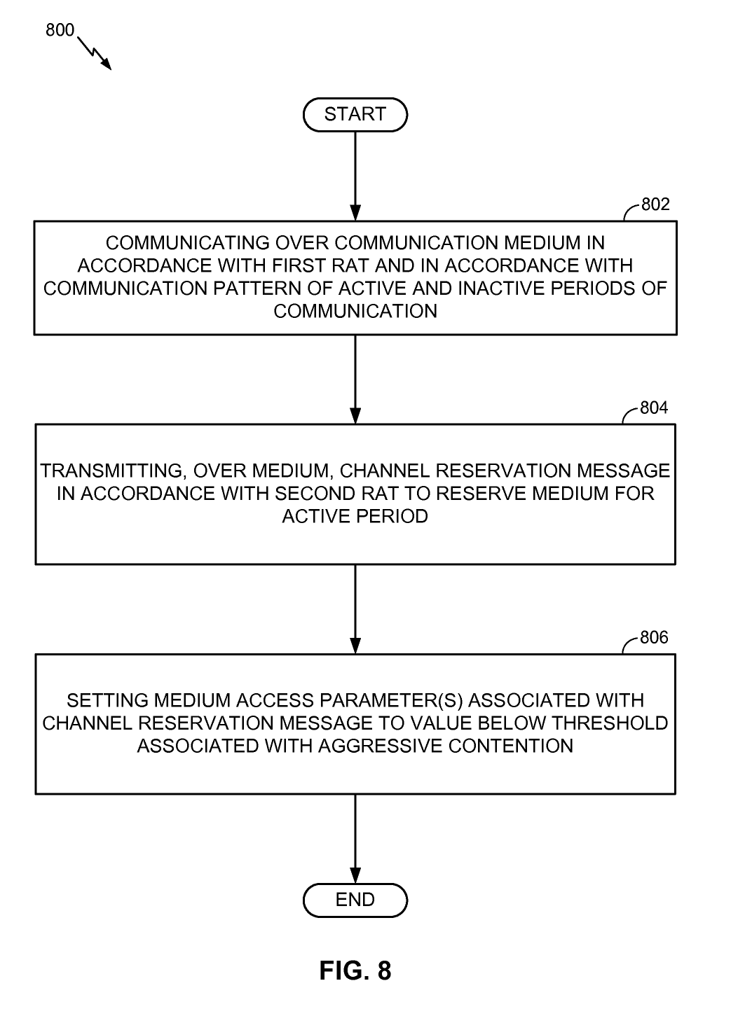

FIG. 8 is a flow diagram illustrating an example method of communication in accordance with the techniques described above. The method 800 may be performed, for example, by an access point (e.g., the access point 110 illustrated in FIG. 1).

As shown, the access point may communicate over a communication medium in accordance with a first RAT and in accordance with a communication pattern of active periods and inactive periods of communication (block 802). The communicating may be performed, for example, by a first transceiver such as the primary-RAT transceiver 140 or the like. As an example, the communication medium may include one or more time, frequency, or space resources on an unlicensed radio frequency band shared between LTE technology and Wi-Fi technology devices. The access point may also transmit, over the communication medium, a channel reservation message in accordance with a second RAT to reserve the communication medium for one of the active periods (block 804). The transmitting may be performed, for example, by a second transceiver such as the secondary-RAT transceiver 142 or the like. The access point may also set one or more medium access parameters associated with the channel reservation message to a value below a threshold associated with aggressive contention (block 806). The setting may be performed, for example, by a processor such as the processing system 116 or the like.

As discussed in more detail above, the one or more medium access parameters may include, for example, a duration of an associated inter-frame spacing period. In addition or as an alternative, the one or more medium access parameters may include, for example, a size of an associated contention window.

In some designs, communicating over the communication medium may be performed in accordance with a TDM communication pattern defining periodic active and inactive periods of communication. In other designs, communicating over the communication medium may be performed in accordance with an LBT communication pattern defining conditional active and inactive periods of communication.

For convenience, the access point 110 and the access terminal 120 are shown in FIG. 1 as including various components that may be configured according to the various examples described herein. It will be appreciated, however, that the illustrated blocks may be implemented in various ways. In some implementations, the components of FIG. 1 may be implemented in one or more circuits such as, for example, one or more processors and/or one or more ASICs (which may include one or more processors). Here, each circuit may use and/or incorporate at least one memory component for storing information or executable code used by the circuit to provide this functionality.

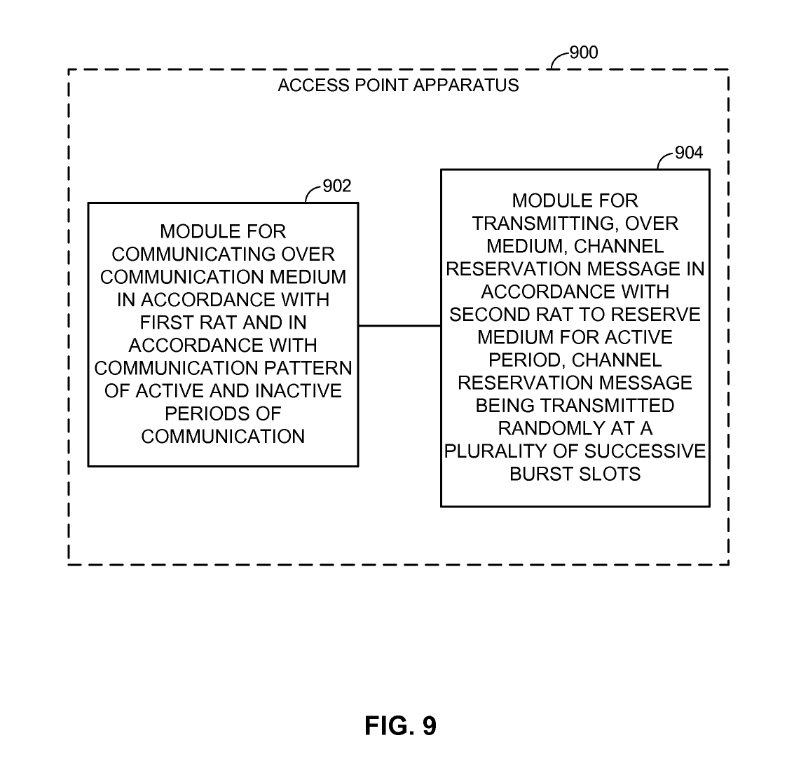

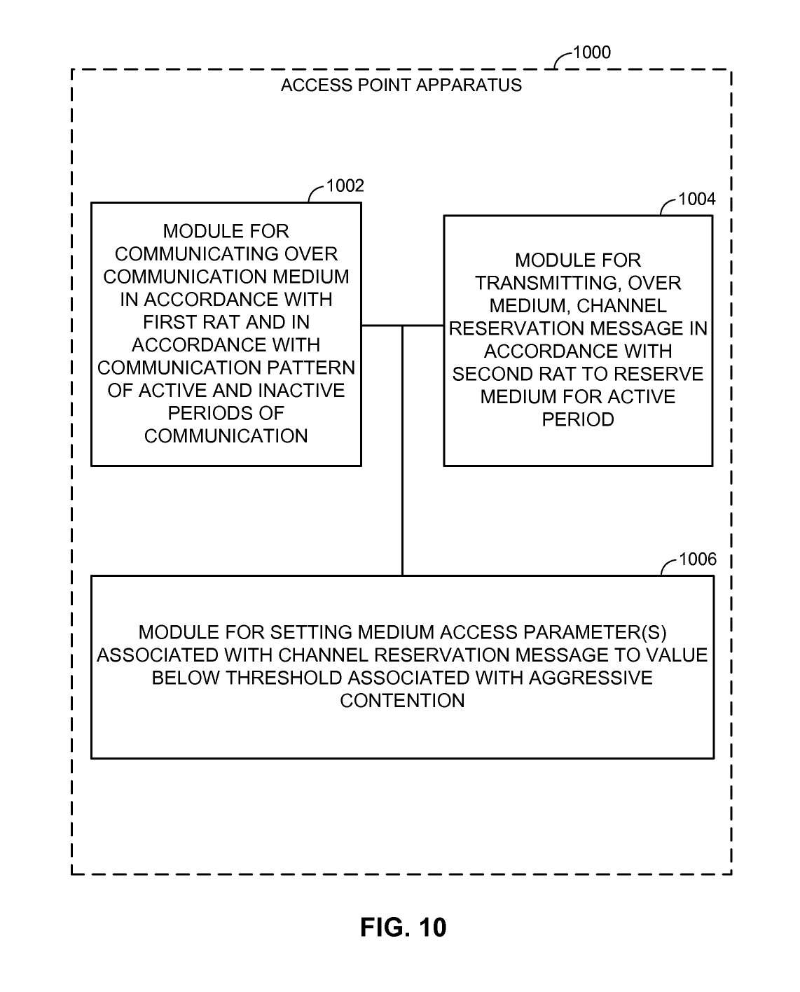

FIGS. 9-10 provide alternative illustrations of apparatuses for implementing the access point 110 and/or the access terminal 120 represented as a series of interrelated functional modules.

FIG. 9 illustrates an example access point apparatus 900 represented as a series of interrelated functional modules. A module for communicating 902 may correspond at least in some aspects to, for example, a communication device or a component thereof as discussed herein (e.g., the communication device 112 or the like). A module for transmitting 904 may correspond at least in some aspects to, for example, a communication device or a component thereof as discussed herein (e.g., the communication device 112 or the like).

FIG. 10 illustrates an example access point apparatus 1000 represented as a series of interrelated functional modules. A module for communicating 1002 may correspond at least in some aspects to, for example, a communication device or a component thereof as discussed herein (e.g., the communication device 122 or the like). A module for transmitting 1004 may correspond at least in some aspects to, for example, a communication device or a component thereof as discussed herein (e.g., the communication device 122 or the like). A module for setting 1006 may correspond at least in some aspects to, for example, a communication controller or a component thereof as discussed herein (e.g., the communication controller 124 or the like).

The functionality of the modules of FIGS. 9-10 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 9-10, as well as other components and functions described herein, may be implemented using any suitable means. Such means also may be implemented, at least in part, using corresponding structure as taught herein. For example, the components described above in conjunction with the “module for” components of FIGS. 9-10 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of storage medium known in the art, transitory or non-transitory. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a transitory or non-transitory computer-readable medium embodying a method for managing operation on a communication medium shared between RATs.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A communication apparatus, comprising:
a first transceiver configured to communicate over a communication medium in accordance with a first Radio Access Technology (RAT) and in accordance with a communication pattern of active periods and inactive periods of communication;
a second transceiver configured to transmit, over the communication medium, a channel reservation message in accordance with a second RAT to reserve the communication medium for one of the active periods;
at least one processor; and
at least one memory coupled to the at least one processor, the at least one processor and the at least one memory being configured to direct the second transceiver to randomly transmit the channel reservation message at a plurality of successive burst slots.

2. The communication apparatus of claim 1, the plurality of successive burst slots being spaced apart by a duration that is less than a threshold amount of time associated with a contention-based inter-frame spacing defined for the second RAT.

3. The communication apparatus of claim 1, the at least one processor and the at least one memory being configured to direct the first transceiver to randomly transmit the channel reservation message in accordance with a probability derived from a number of neighboring first RAT nodes, a reservation duration required by each of the neighboring first RAT nodes, or a combination thereof.

4. The communication apparatus of claim 3, the at least one processor and the at least one memory being further configured to set the probability for a first burst slot among the plurality of successive burst slots to 1.

5. The communication apparatus of claim 1, the at least one processor and the at least one memory being configured to direct the first transceiver to transmit a packet preamble at each burst slot among the plurality of successive burst slots in which the channel reservation message is not transmitted.

6. The communication apparatus of claim 1, the first transceiver being configured to communicate over the communication medium in accordance with a Time Division Multiplexing (TDM) communication pattern defining periodic active and inactive periods of communication.

7. The communication apparatus of claim 1, the first transceiver being configured to communicate over the communication medium in accordance with a Listen Before Talk (LBT) communication pattern defining conditional active and inactive periods of communication.

8. The communication apparatus of claim 1:
the communication medium comprising one or more time, frequency, or space resources on an unlicensed radio frequency band;
the first RAT comprising Long Term Evolution (LTE) technology; and
the second RAT comprising Wi-Fi technology.

9. A communication method, comprising:
communicating over a communication medium in accordance with a first Radio Access Technology (RAT) and in accordance with a communication pattern of active periods and inactive periods of communication; and
transmitting, over the communication medium, a channel reservation message in accordance with a second RAT to reserve the communication medium for one of the active periods, the channel reservation message being transmitted randomly at a plurality of successive burst slots.

10. The method of claim 9, the plurality of successive burst slots being spaced apart by a duration that is less than a threshold amount of time associated with a contention-based inter-frame spacing defined for the second RAT.

11. The method of claim 9, further comprising randomly transmitting the channel reservation message in accordance with a probability derived from a number of neighboring first RAT nodes, a reservation duration required by each of the neighboring first RAT nodes, or a combination thereof.

12. The method of claim 11, further comprising setting the probability for a first burst slot among the plurality of successive burst slots to 1.

13. The method of claim 9, further comprising transmitting a packet preamble at each burst slot among the plurality of successive burst slots in which the channel reservation message is not transmitted.

14. The method of claim 9, the communicating comprising communicating over the communication medium in accordance with a Time Division Multiplexing (TDM) communication pattern defining periodic active and inactive periods of communication.

15. The method of claim 9, the communicating comprising communicating over the communication medium in accordance with a Listen Before Talk (LBT) communication pattern defining conditional active and inactive periods of communication.

16. The method of claim 9:
the communication medium comprising one or more time, frequency, or space resources on an unlicensed radio frequency band;
the first RAT comprising Long Term Evolution (LTE) technology; and
the second RAT comprising Wi-Fi technology.

17. A communication apparatus, comprising:
means for communicating over a communication medium in accordance with a first Radio Access Technology (RAT) and in accordance with a communication pattern of active periods and inactive periods of communication; and
means for transmitting, over the communication medium, a channel reservation message in accordance with a second RAT to reserve the communication medium for one of the active periods, the channel reservation message being transmitted randomly at a plurality of successive burst slots.

18. The communication apparatus of claim 17, the plurality of successive burst slots being spaced apart by a duration that is less than a threshold amount of time associated with a contention-based inter-frame spacing defined for the second RAT.

19. The communication apparatus of claim 17, further comprising means for randomly transmitting the channel reservation message in accordance with a probability derived from a number of neighboring first RAT nodes, a reservation duration required by each of the neighboring first RAT nodes, or a combination thereof.

20. The communication apparatus of claim 19, further comprising means for setting the probability for a first burst slot among the plurality of successive burst slots to 1.

21. The communication apparatus of claim 17, further comprising means for transmitting a packet preamble at each burst slot among the plurality of successive burst slots in which the channel reservation message is not transmitted.

22. The communication apparatus of claim 17, the means for communicating comprising means for communicating over the communication medium in accordance with a Time Division Multiplexing (TDM) communication pattern defining periodic active and inactive periods of communication.

23. The communication apparatus of claim 17, the means for communicating comprising means for communicating over the communication medium in accordance with a Listen Before Talk (LBT) communication pattern defining conditional active and inactive periods of communication.

24. The communication apparatus of claim 17:
the communication medium comprising one or more time, frequency, or space resources on an unlicensed radio frequency band;
the first RAT comprising Long Term Evolution (LTE) technology; and
the second RAT comprising Wi-Fi technology.

25. A non-transitory computer-readable medium, comprising:
code for communicating over a communication medium in accordance with a first Radio Access Technology (RAT) and in accordance with a communication pattern of active periods and inactive periods of communication; and
code for transmitting, over the communication medium, a channel reservation message in accordance with a second RAT to reserve the communication medium for one of the active periods, the channel reservation message being transmitted randomly at a plurality of successive burst slots.

26. The non-transitory computer-readable medium of claim 25, the plurality of successive burst slots being spaced apart by a duration that is less than a threshold amount of time associated with a contention-based inter-frame spacing defined for the second RAT.

27. The non-transitory computer-readable medium of claim 25, further comprising code for randomly transmitting the channel reservation message in accordance with a probability derived from a number of neighboring first RAT nodes, a reservation duration required by each of the neighboring first RAT nodes, or a combination thereof.

28. The non-transitory computer-readable medium of claim 27, further comprising code for setting the probability for a first burst slot among the plurality of successive burst slots to 1.

29. The non-transitory computer-readable medium of claim 25, further comprising code for transmitting a packet preamble at each burst slot among the plurality of successive burst slots in which the channel reservation message is not transmitted.

30. The non-transitory computer-readable medium of claim 25, the code for communicating comprising code for communicating over the communication medium in accordance with a Time Division Multiplexing (TDM) communication pattern defining periodic active and inactive periods of communication.

31. The non-transitory computer-readable medium of claim 25, the code for communicating comprising code for communicating over the communication medium in accordance with a Listen Before Talk (LBT) communication pattern defining conditional active and inactive periods of communication.

32. The non-transitory computer-readable medium of claim 25:
the communication medium comprising one or more time, frequency, or space resources on an unlicensed radio frequency band;
the first RAT comprising Long Term Evolution (LTE) technology; and
the second RAT comprising Wi-Fi technology.

33. A communication apparatus, comprising:
a first transceiver configured to communicate over a communication medium in accordance with a first Radio Access Technology (RAT) and in accordance with a communication pattern of active periods and inactive periods of communication;
a second transceiver configured to transmit, over the communication medium, a channel reservation message in accordance with a second RAT to reserve the communication medium for one of the active periods;
at least one processor; and
at least one memory coupled to the at least one processor, the at least one processor and the at least one memory being configured to set one or more medium access parameters associated with the channel reservation message to a value below a threshold associated with aggressive contention.

34. The communication apparatus of claim 33, the one or more medium access parameters including a duration of an associated inter-frame spacing period.

35. The communication apparatus of claim 33, the one or more medium access parameters including a size of an associated contention window.

36. The communication apparatus of claim 33, the first transceiver being configured to communicate over the communication medium in accordance with a Time Division Multiplexing (TDM) communication pattern defining periodic active and inactive periods of communication.

37. The communication apparatus of claim 33, the first transceiver being configured to communicate over the communication medium in accordance with a Listen Before Talk (LBT) communication pattern defining conditional active and inactive periods of communication.

38. The communication apparatus of claim 33:
the communication medium comprising one or more time, frequency, or space resources on an unlicensed radio frequency band;
the first RAT comprising Long Term Evolution (LTE) technology; and
the second RAT comprising Wi-Fi technology.

39. A communication method, comprising:
communicating over a communication medium in accordance with a first Radio Access Technology (RAT) and in accordance with a communication pattern of active periods and inactive periods of communication;
transmitting, over the communication medium, a channel reservation message in accordance with a second RAT to reserve the communication medium for one of the active periods; and
setting one or more medium access parameters associated with the channel reservation message to a value below a threshold associated with aggressive contention.

40. The method of claim 39, the one or more medium access parameters including a duration of an associated inter-frame spacing period.

41. The method of claim 39, the one or more medium access parameters including a size of an associated contention window.

42. The method of claim 39, the communicating comprising communicating over the communication medium in accordance with a Time Division Multiplexing (TDM) communication pattern defining periodic active and inactive periods of communication.

43. The method of claim 39, the communicating comprising communicating over the communication medium in accordance with a Listen Before Talk (LBT) communication pattern defining conditional active and inactive periods of communication.

44. The method of claim 39:
the communication medium comprising one or more time, frequency, or space resources on an unlicensed radio frequency band;
the first RAT comprising Long Term Evolution (LTE) technology; and
the second RAT comprising Wi-Fi technology.

45. A communication apparatus, comprising:
means for communicating over a communication medium in accordance with a first Radio Access Technology (RAT) and in accordance with a communication pattern of active periods and inactive periods of communication;
means for transmitting, over the communication medium, a channel reservation message in accordance with a second RAT to reserve the communication medium for one of the active periods; and
means for setting one or more medium access parameters associated with the channel reservation message to a value below a threshold associated with aggressive contention.

46. The communication apparatus of claim 45, the one or more medium access parameters including a duration of an associated inter-frame spacing period.

47. The communication apparatus of claim 45, the one or more medium access parameters including a size of an associated contention window.

48. The communication apparatus of claim 45, the means for communicating comprising means for communicating over the communication medium in accordance with a Time Division Multiplexing (TDM) communication pattern defining periodic active and inactive periods of communication.

49. The communication apparatus of claim 45, the means for communicating comprising means for communicating over the communication medium in accordance with a Listen Before Talk (LBT) communication pattern defining conditional active and inactive periods of communication.

50. The communication apparatus of claim 45:
the communication medium comprising one or more time, frequency, or space resources on an unlicensed radio frequency band;
the first RAT comprising Long Term Evolution (LTE) technology; and
the second RAT comprising Wi-Fi technology.

51. A non-transitory computer-readable medium, comprising:
code for communicating over a communication medium in accordance with a first Radio Access Technology (RAT) and in accordance with a communication pattern of active periods and inactive periods of communication;
code for transmitting, over the communication medium, a channel reservation message in accordance with a second RAT to reserve the communication medium for one of the active periods; and
code for setting one or more medium access parameters associated with the channel reservation message to a value below a threshold associated with aggressive contention.

52. The non-transitory computer-readable medium of claim 51, the one or more medium access parameters including a duration of an associated inter-frame spacing period.

53. The non-transitory computer-readable medium of claim 51, the one or more medium access parameters including a size of an associated contention window.

54. The non-transitory computer-readable medium of claim 51, the code for communicating comprising code for communicating over the communication medium in accordance with a Time Division Multiplexing (TDM) communication pattern defining periodic active and inactive periods of communication.

55. The non-transitory computer-readable medium of claim 51, the code for communicating comprising code for communicating over the communication medium in accordance with a Listen Before Talk (LBT) communication pattern defining conditional active and inactive periods of communication.

56. The non-transitory computer-readable medium of claim 51:
the communication medium comprising one or more time, frequency, or space resources on an unlicensed radio frequency band;
the first RAT comprising Long Term Evolution (LTE) technology; and
the second RAT comprising Wi-Fi technology.
